(19) United States
(12) Patent Application Publication
(10) Pub. No.: US 2015/0357622 A1
(43) Pub. Date: Dec. 10, 2015

(54) LITHIUM ION ELECTRICITY STORAGE DEVICE

(71) Applicant: KABUSHIKI KAISHA TOYOTA JIDOSHOKKI, Kariya-shi, Aichi (JP)

(72) Inventors: Shimpei MUNE, Kariya-shi, Aichi (JP); Yushi KONDO, Kariya-shi, Aichi (JP); Motoaki OKUDA, Kariya-shi, Aichi (JP); Hirokuni AKIYAMA, Kariya-shi, Aichi (JP)

(73) Assignee: KABUSHIKI KAISHA TOYOTA JIDOSHOKKI, Kariya-shi, Aichi (JP)

(21) Appl. No.: 14/761,990

(22) PCT Filed: Jan. 20, 2014
(86) PCT No.: PCT/JP2014/051010

§ 371 Date: Jul. 20, 2015

(30) Foreign Application Priority Data
Jan. 22, 2013 (JP) 2013-009335

(51) Int. Cl. H01M 2/26; H01M 2/02; H01M 10/0525

(52) U.S. Cl. CPC H01M 2/26; H01M 10/0525; H01M 2/0237; H01M 2220/20

(57) ABSTRACT

A lithium ion secondary battery (100) includes a case (10), an electrode assembly (20), a first metal plate (12), a second metal plate (14), and an insulating member (16). The electrode assembly (20) includes a positive electrode (30), a negative electrode (40), and a separator (50). The first metal plate (12) is electrically connected to the positive electrode (30). The second metal plate (14) is electrically connected to the negative electrode (40). The first metal plate (12) is thicker than a positive electrode metal foil (30B). The second metal plate (14) is thicker than a negative electrode metal foil (40B). When the thickness of the first metal plate (12) is designated as D1, and the thickness of the second metal plate (14) is designated as D2, the relationship: 1<D1/D2<2 is satisfied.

### TECHNICAL FIELD

The present invention relates to a lithium ion electricity storage device.

### BACKGROUND ART

A lithium ion secondary battery in which a metal portion having a potential equal to that of the positive electrode and a metal portion having a potential equal to that of the negative electrode are arranged to face each other on the outside of a coil type electrode assembly, is known (see, for example, Patent Literature 1). In this lithium ion secondary battery, rapid heat generation in the active material layers inside the electrode assembly is suppressed by the metal portion having a potential equal to that of the positive electrode and the metal portion having a potential equal to that of the negative electrode are short-circuited.

### CITATION LIST

Patent Literature
Patent Literature 1: JP 11-185798 A

### SUMMARY OF INVENTION

### Technical Problem

In the lithium ion secondary battery described above, the end part of a metal foil that constitutes the positive electrode in the electrode assembly corresponds to the metal portion having a potential equal to that of the positive electrode. Similarly, the end part of metal foil that constitutes the negative electrode in the electrode assembly corresponds to the metal portion having a potential equal to that of the negative electrode. Accordingly, the thickness of the metal portion having a potential equal to that of the positive electrode is the same as the thickness of the metal foil that constitutes the positive electrode. Similarly, the thickness of the metal portion having a potential equal to that of the negative electrode is the same as the thickness of the metal foil that constitutes the negative electrode. Since the thickness of the metal foil that constitutes the positive electrode or the negative electrode is usually thin, the metal portion having a potential equal to that of the positive electrode or the negative electrode is also thin. Therefore, there is a risk that the metal portion having a potential equal to that of the positive electrode or the negative electrode may melt due to the heat generation at the time of a short circuit, and a short circuit may be eliminated.

On the other hand, in order to increase the capacity of a lithium ion secondary battery in a confined space inside the battery can, it is desirable to make the aforementioned metal portion that does not contribute to the capacity of the battery as thin as possible.

Thus, it is an object of the present invention to provide a lithium ion electricity storage device which can maintain a short circuit between metal plates more reliably while increasing the capacity of the electricity storage device in a confined space.

### Solution to Problem

A lithium ion electricity storage device related to an aspect of the invention includes a case; an electrode assembly accommodated in the case; a first metal plate disposed between the case and the electrode assembly; a second metal plate disposed between the first metal plate and the electrode assembly; and an insulating member disposed between the first metal plate and the second metal plate, in which the electrode assembly includes a positive electrode, a negative electrode, and a separator disposed between the positive electrode and the negative electrode; the first metal plate is electrically connected to the positive electrode; the second metal plate is electrically connected to the negative electrode; the first metal plate is made of an aluminum-based metal; the second metal plate is made of a metal that does not alloy with lithium at a potential of 3 V or less with respect to a lithium potential; the positive electrode includes a positive electrode metal foil and a positive electrode active material layer provided on the positive electrode metal foil; the negative electrode includes a negative electrode metal foil and a negative electrode active material layer provided on the negative electrode metal foil; the first metal plate is thicker than the positive electrode metal foil; the second metal plate is thicker than the negative electrode metal foil; and when the thickness of the first metal plate is designated as D1, and the thickness of the second metal plate is designated as D2, the relationship: 1<D1/D2<2 is satisfied.

In this lithium ion electricity storage device, since the first metal plate and the second metal plate can be made sufficiently thick, even if the first metal plate and the second metal plate are short-circuited and generate heat, the first metal plate and the second metal plate do not easily melt. Furthermore, the total thickness of the first metal plate and the second metal plate that do not contribute to the capacity of the electricity storage device can be made small, while melting of the first metal plate and the second metal plate is suppressed. Therefore, a short circuit between the first metal plate and the second metal plate can be maintained more reliably while the capacity of the electricity storage device in a confined space is increased.

The thickness of the second metal plate may be 0.1 mm or more.

The second metal plate may be made of a copper-based metal.

The relationship: 1<D1/D2<1.5 may be satisfied.

### Advantageous Effects of Invention

According to the present invention, a lithium ion electricity storage device which can maintain a short circuit between metal plates more reliably, while increasing the capacity of the electricity storage device in a confined space, can be provided.

### BRIEF DESCRIPTION OF DRAWINGS

FIG. 1 is a cross-sectional view schematically illustrating a lithium ion electricity storage device according to an embodiment.

FIG. 2 is a cross-sectional view of the lithium ion electricity storage device cut along the line II-II in FIG. 1.

FIG. 3 is a diagram illustrating the conditions for Experimental Examples of changing the thicknesses of the first metal plate (Al) and the second metal plate (Cu).

FIG. 4 is a diagram schematically illustrating an example of an electric circuit in a case in which the first metal plate (Al) and the second metal plate (Cu) are short-circuited.

FIG. 5 is a graph illustrating an example of the relationship between the thickness of the first metal plate (Al) or the thickness of the second metal plate (Cu) and the electric current.

### DESCRIPTION OF EMBODIMENTS

Hereinafter, embodiments of the present invention are described in detail with reference to the attached drawings. In the description of the drawings, identical symbols are assigned to identical or equivalent elements, and any overlapping descriptions will not be repeated.

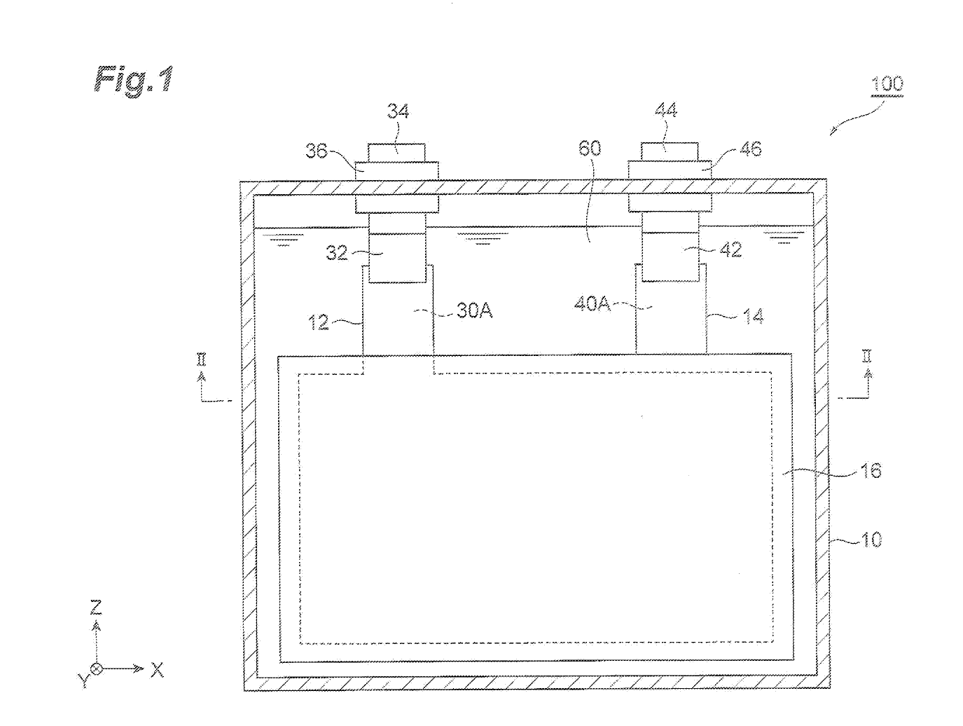

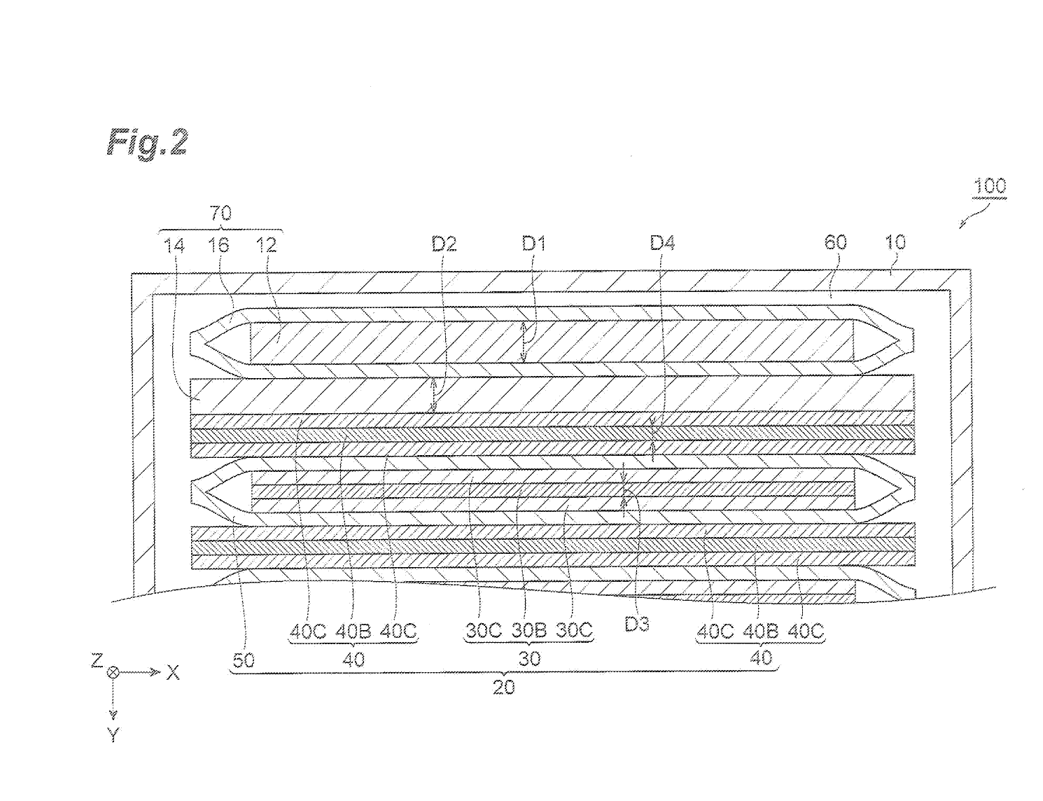

FIG. 1 is a cross-sectional view schematically illustrating a lithium ion electricity storage device related to an embodiment. FIG. 2 is a cross-sectional view of the lithium ion electricity storage device cut along the line II-II in FIG. 1. FIG. 1 and FIG. 2 illustrate an XYZ rectangular coordinate system.

A lithium ion secondary battery 100 illustrated in FIG. 1 and FIG. 2 includes a case 10, and an electrode assembly 20 accommodated in the case 10. The case 10 may be made of, for example, an aluminum-based metal or a metal such as stainless steel. The electrode assembly 20 includes a positive electrode 30, a negative electrode 40, and a separator 50 disposed between the positive electrode 30 and the negative electrode 40. The positive electrode 30 and the negative electrode 40 are, for example, in a sheet form. The separator 50 is, for example, bag-shaped, but a sheet form is still acceptable. Inside the bag-shaped separator 50, for example, the positive electrode 30 is accommodated. Plural positive electrodes 30 and plural negative electrodes 40 may be, for example, alternately laminated in the Y-axis direction, with the separator 50 interposed therebetween. The case 10 can be filled with a liquid electrolyte 60. Examples of the liquid electrolyte 60 include organic solvent-based or non-aqueous liquid electrolytes.

The positive electrode 30 includes a positive electrode metal foil 30B and a positive electrode active material layer 30C provided on the positive electrode metal foil 30B. The positive electrode active material layer 30C can be provided on both surfaces of the positive electrode metal foil 30B. The positive electrode metal foil 30B is, for example, an aluminum foil. The positive electrode active material layer 30C may contain a positive electrode active material and a binder. Examples of the positive electrode active material include a composite oxide, lithium metal, and sulfur. The composite oxide contains lithium and at least one of manganese, nickel, cobalt and aluminum.

The positive electrode 30 may have a tab 30A formed on edge. The tab 30A does not retain a positive electrode active material. The positive electrode 30 can be connected to a conductive member 32 through the tab 30A. The conductive member 32 can be connected to a positive electrode terminal 34. The positive electrode terminal 34 may be mounted to the case 10 via an insulating ring 36.

The negative electrode 40 includes a negative electrode metal foil 40B and a negative electrode active material layer 40C provided on the negative electrode metal foil 40B. The negative electrode active material layer 40C can be provided on both surfaces of the negative electrode metal foil 40B. The negative electrode metal foil 40B is, for example, a copper foil. The negative electrode active material layer 40C may contain a negative electrode active material and a binder. Examples of the negative electrode active material include carbon materials such as graphite, highly oriented graphite, mesocarbon microbeads, hard carbon, and soft carbon; alkali metals such as lithium and sodium; metal compounds; metal oxides such as SiOₓ (0.5≦x≦1.5); and boron-added carbon.

The negative electrode 40 may have a tab 40A formed on edge. The tab 40A does not retain a negative electrode active material. The negative electrode 40 can be connected to a conductive member 42 through the tab 40A. The conductive member 42 can be connected to a negative electrode terminal 44. The negative electrode terminal 44 may be mounted to the case 10 via an insulating ring 46.

Examples of the separator 50 include a porous film formed from a polyolefin-based resin such as polyethylene (PE) or polypropylene (PP); and a woven fabric or a nonwoven fabric formed from polypropylene, polyethylene terephthalate (PET), methyl cellulose, or the like.

The lithium ion secondary battery 100 includes a first metal plate 12, a second metal plate 14, and an insulating member 16. The first metal plate 12 is disposed between the case 10 and the electrode assembly 20. The second metal plate 14 is disposed between the first metal plate 12 and the electrode assembly 20. The insulating member 16 is disposed between the first metal plate 12 and the second metal plate 14. The first metal plate 12, the second metal plate 14, and the insulating member 16 can constitute a short circuit unit (safety measure unit) 70. The first metal plate 12, the second metal plate 14, and the insulating member 16 can be laminated in the Y-axis direction. The electrode assembly 20 may be sandwiched between plural short circuit units 70. The first metal plate 12 and the second metal plate 14 are also referred to as uncoated electrodes.

The first metal plate 12 is electrically connected to the positive electrode 30. The second metal plate 14 is electrically connected to the negative electrode 40. The first metal plate 12 is made of an aluminum-based metal. The aluminum-based metal includes pure aluminum or an aluminum alloy. The second metal plate 14 is made of a metal which does not alloy with lithium at a potential of 3 V or less with respect to the lithium potential. Examples of such a metal include a copper-based metal, stainless steel (SUS), and nickel. The copper-based metal includes pure copper or a copper alloy.

The first metal plate 12 may include, for example, plural sheets of a metal foil that are laminated, or may be a single plate-shaped member. The first metal plate 12 is not provided with an active material layer. The first metal plate 12 is thicker than the positive electrode metal foil 30B. The first metal plate 12 may have a main body unit and a tab formed at the edge of the main body unit. When viewed in the thickness direction (Y-axis direction) of the first metal plate 12, the tab of the first metal plate 12 can be disposed so as to overlap the tab 30A of the positive electrode 30 and can be connected to the tab 30A by welding.

The second metal plate 14 may include, for example, plural sheets of a metal foil that are laminated, or may be a single plate-shaped member. The second metal plate 14 is not provided with an active material layer. The second metal plate 14 is thicker than the negative electrode metal foil 40B. The second metal plate 14 may have a main body unit and a tab formed at the edge of the main body unit. When viewed in the thickness direction (Y-axis direction) of the second metal plate 14, the tab of the second metal plate 14 can be disposed so as to overlap the tab 40A of the negative electrode 40 and can be connected to the tab 40A by welding.

When the thickness of the first metal plate 12 is designated as D1, and the thickness of the second metal plate 14 is designated as D2, the relationship: 1<D1/D2<2 is satisfied. The relationship: 1<D1/D2<1.5 may be satisfied, the relationship: 1.04≦D1/D2≦1.46 may be satisfied, and the relationship: 1.04≦D1/D2≦1.39 may be satisfied. The value of D1/D2 is, for example, 1.19. In a case in which the first metal plate 12 includes plural sheets of a metal foil, the thickness D1 of the first metal plate 12 is the total thickness of the plural sheets of the metal foil. In a case in which the second metal plate 14 includes plural sheets of a metal foil, the thickness D2 of the second metal plate 14 is the total thickness of the plural sheets of the metal foil.

The thickness of the first metal plate 12 is, for example, larger than 0.1 mm. The thickness of the first metal plate 12 is, for example, 2 mm or less. The thickness of the second metal plate 14 is, for example, 0.1 mm or more. The thickness of the second metal plate 14 is, for example, less than 2 mm. Meanwhile, the thicknesses of the first metal plate 12 and the second metal plate 14 may be thicker or thinner in accordance with the battery size or the battery capacity.

In the lithium ion secondary battery 100, since the first metal plate 12 and the second metal plate 14 can be made sufficiently thick, even if the first metal plate 12 and the second metal plate 14 are short-circuited and generate heat, the first metal plate 12 and the second metal plate 14 do not easily melt. Furthermore, the total thickness (D1+D2) of the first metal plate 12 and the second metal plate 14 that do not contribute to the capacity of the battery can be made small while melting of the first metal plate 12 and the second metal plate 14 is suppressed. Accordingly, a short circuit between the first metal plate 12 and the second metal plate 14 can be maintained more reliably while the capacity of the battery in a confined space is increased.

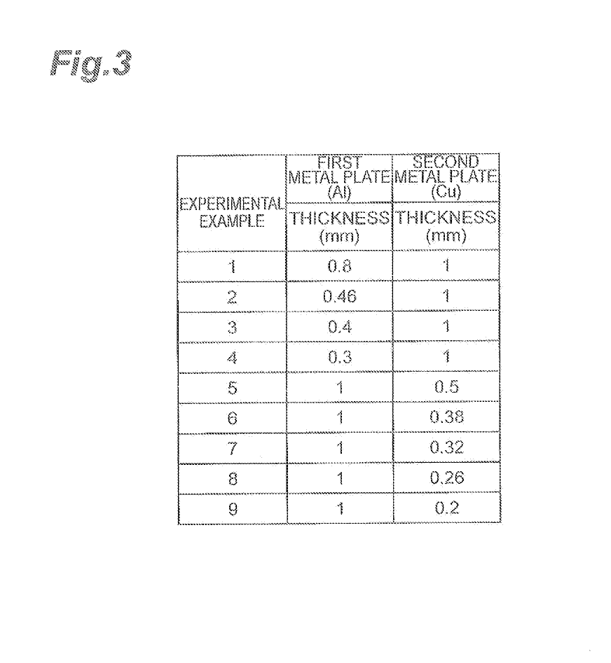

FIG. 3 is a diagram illustrating the conditions for Experimental Examples of changing the thicknesses of the first metal plate (Al) and the second metal plate (Cu). In Experimental Examples 1 to 9, a first metal plate (Al) including plural sheets of aluminum foils and a second metal plate (Cu) including plural sheets of a copper foil were used. In Experimental Examples 1 to 4, the total thickness of the plural sheets of the copper foil was fixed at 1 mm. In Experimental Examples 5 to 9, the total thickness of the plural sheets of the aluminum foil was fixed at 1 mm.

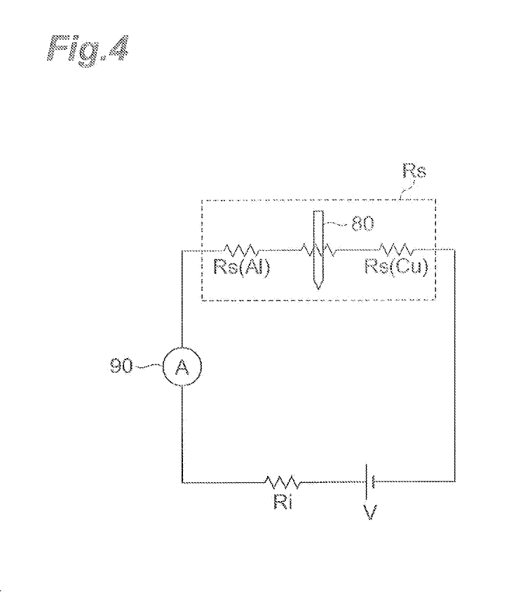

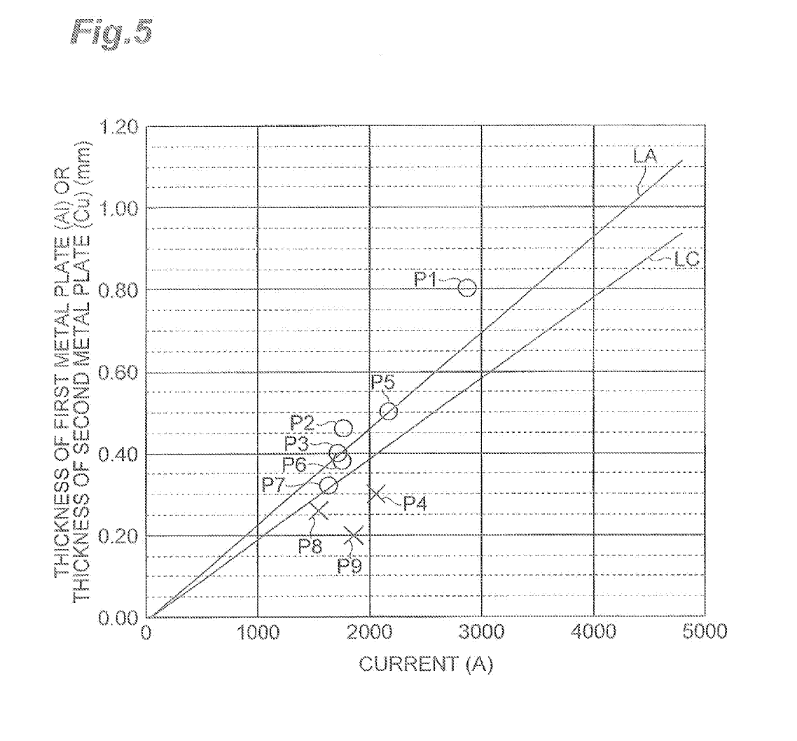

FIG. 4 is a diagram schematically illustrating an example of an electric circuit in a case in which the first metal plate (Al) and the second metal plate (Cu) are short-circuited. In each of Experimental Examples 1 to 9, as illustrated in FIG. 4, the electrode assembly and the short circuit unit were connected by a wiring through an ammeter 90. The first metal plate (Al) and the second metal plate (Cu) in the short circuit were short-circuited by sticking a nail 80 to the short circuit unit. In FIG. 4, Ri represents the internal resistance of the electrode assembly. V represents the electromotive force of the electrode assembly. Rs represents the resistance of the short circuit unit. Rs(Al) represents the resistance of the first metal plate (Al). Rs(Cu) represents the resistance of the second metal plate (Cu). The electric current value was measured using an ammeter 90. The results are presented in FIG. 5.

FIG. 5 is a graph illustrating an example of the relationship between the thickness of the first metal plate (Al) or the thickness of the second metal plate (Cu) and the electric current. For the results of Experimental Examples 1 to 9, points P1 to P9 were respectively plotted. In FIG. 5, ◯ represents that a short circuit is maintained, and X represents that a short circuit has been eliminated. In Experimental Examples 1 to 3 and 5 to 7, short circuits were maintained; however, in Experimental Examples 4, 8 and 9, short circuits were eliminated. In Experimental Example 4, the first metal plate (Al) melted due to heat generation caused by a short circuit. In Experimental Examples 8 and 9, the second metal plate (Cu) melted due to heat generation caused by a short circuit. The gradient of straight line LA that passes through the point of origin and point P3 was 1/4315 (mm/A), and the gradient of straight line LC that passes through the point of origin and point P7 was 1/5137 (mm/A). When the gradient of the straight line LA is divided by the gradient of the straight line LC, 1.19 is obtained. On the straight lines LA and LC, the thickness of the first metal plate (Al) is 1.19 times the thickness of the second metal plate (Cu). From the results of Experimental Examples 1 to 9, it is understood that when the thickness of the first metal plate (Al) is in the range of a value larger than the thickness of the second metal plate (Cu) and smaller than twice the thickness of the second metal plate (Cu), the total thickness of the first metal plate (Al) and the second metal plate (Cu) can be made small while melting of the first metal plate (Al) and the second metal plate (Cu) is suppressed.

As discussed above, suitable embodiments of the present invention have been described in detail; however, the present invention is not intended to be limited to the embodiments described above.

For example, the lithium ion secondary battery 100 may be mounted to a vehicle. Examples of the vehicle include an electric vehicle, a hybrid vehicle, a plug-in hybrid vehicle, a hybrid railroad vehicle, an electric wheelchair, an electric assist bicycle, and an electric motorcycle.

A coil type electrode assembly may be used instead of the laminate type electrode assembly 20. A coil type electrode assembly is produced by coiling a band-shaped positive electrode, a band-shaped negative electrode, and a band-shaped separator about an axial line.

The present invention may also be applied to a lithium ion capacitor instead of the lithium ion secondary battery 100.

### REFERENCE SIGNS LIST

10 CASE
12 FIRST METAL PLATE
14 SECOND METAL PLATE
16 INSULATING MEMBER
20 ELECTRODE ASSEMBLY
30 POSITIVE ELECTRODE
30B POSITIVE ELECTRODE METAL FOIL
30C POSITIVE ELECTRODE ACTIVE MATERIAL LAYER
40 NEGATIVE ELECTRODE
40B NEGATIVE ELECTRODE METAL FOIL
40C NEGATIVE ELECTRODE ACTIVE MATERIAL LAYER
50 SEPARATOR
100 LITHIUM ION SECONDARY BATTERY (LITHIUM ION ELECTRICITY STORAGE DEVICE)

1. A lithium ion electricity storage device, comprising:
a case;
an electrode assembly accommodated in the case;
a first metal plate disposed between the case and the electrode assembly;
a second metal plate disposed between the first metal plate and the electrode assembly; and
an insulating member disposed between the first metal plate and the second metal plate,
wherein the electrode assembly includes a positive electrode, a negative electrode, and a separator disposed between the positive electrode and the negative electrode,
wherein the first metal plate is electrically connected to the positive electrode,
wherein the second metal plate is electrically connected to the negative electrode,
wherein the first metal plate is made of an aluminum-based metal,
wherein the second metal plate is made of a metal which does not alloy with lithium at a potential of 3 V or less with respect to a lithium potential,
wherein the positive electrode includes a positive electrode metal foil and a positive electrode active material layer provided on the positive electrode metal foil,
wherein the negative electrode includes a negative electrode metal foil and a negative electrode active material layer provided on the negative electrode metal foil,
wherein the first metal plate is thicker than the positive electrode metal foil,
wherein the second metal plate is thicker than the negative electrode metal foil, and
wherein when a thickness of the first metal plate is designated as D1, and a thickness of the second metal plate is designated as D2, a relationship: 1<D1/D2<2 is satisfied.

2. The lithium ion electricity storage device according to claim 1, wherein the thickness of the second metal plate is 0.1 mm or more.

3. The lithium ion electricity storage device according to claim 1, wherein the second metal plate is made of a copper-based metal.

4. The lithium ion electricity storage device according to claim 1, wherein a relationship: 1<D1/D2<1.5 is satisfied.

5. The lithium ion electricity storage device according to claim 1, wherein a relationship: 1<D1/D2<1.39 is satisfied.

6. The lithium ion electricity storage device according to claim 5, wherein a relationship: 1<D1/D2≦1.19 is satisfied.

7. The lithium ion electricity storage device according to claim 6, wherein D1/D2 is 1.19.

8. The lithium ion electricity storage device according to claim 1, wherein the thickness of the first metal plate is more than 0.3 mm.

9. The lithium ion electricity storage device according to claim 8, wherein the thickness of the first metal plate is 0.4 mm or more.

10. The lithium ion electricity storage device according to claim 1, wherein the thickness of the first metal plate is 2 mm or less.

11. The lithium ion electricity storage device according to claim 2, wherein the thickness of the second metal plate is more than 0.26 mm.

12. The lithium ion electricity storage device according to claim 11, wherein the thickness of the second metal plate is 0.32 mm or more.

13. The lithium ion electricity storage device according to claim 1, wherein the thickness of the second metal plate is less than 2 mm.
